(19) United States
(12) Patent Application Publication
(10) Pub. No.: US 2026/0322550 A1
(43) Pub. Date: Oct. 15, 2026

(54) PRIORITIZATION IN PREEMPTION OPERATIONS DURING TRANSMISSION

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 19/637,905

(22) Filed: Apr. 2, 2026

Related U.S. Application Data
(60) Provisional application No. 63/787,607, filed on Apr. 11, 2025.

(51) Int. Cl. H04L 5/00; H04W 72/1268; H04W 72/23

(52) U.S. Cl. CPC H04L 5/0048; H04L 5/0055; H04W 72/1268; H04W 72/23

(57) ABSTRACT

A station (STA) in a wireless network may include a processor coupled to a memory, the processor is to receive, from an access point (AP), a downlink frame including information indicating a reference point in the downlink frame and transmit a preemption request frame after a predetermined interframe space has elapsed from the reference point in the downlink frame when the STA has low latency traffic to transmit. The processor is further to transmit an uplink frame including the low latency traffic after transmitting the preemption request frame.

### CROSS REFERENCE TO RELATED APPLICATIONS

This application claims priority to U.S. Provisional Application No. 63/787,607, filed on Apr. 11, 2025, which is incorporated by reference herein in its entirety.

### TECHNICAL FIELD

This disclosure relates to wireless communication systems, and more specifically, to prioritization mechanisms in preemption operations during downlink data transmission.

### BACKGROUND

The IEEE 802.11 group develops the next generation Wi-Fi standard to achieve higher data rate, lower latency, and more reliable connection to enhance user experience. One of the key features of the next generation Wi-Fi standard is the Multi-Link Operation (MLO). As most current APs and stations incorporate dual-band or tri-band capabilities, the newly developed MLO feature enables packet-level link aggregation in the MAC layer across different PHY links. By performing load balancing according to traffic requirements, MLO can achieve significantly higher throughput and lower latency for enhanced reliability in a heavily loaded network. With the MLO capability, a Multi-Link Device (MLD) comprises multiple “affiliated” devices to the upper logical link control (LLC) layer, allowing concurrent data transmission and reception in multiple channels across a single or multiple frequency bands in 2.4 GHz, 5 GHz and 6 GHz.

There exists Wi-Fi technologies that allow a device to connect to a single link and is capable of switching among 2.4 GHz, 5 GHz and 6 GHz bands. However, such Wi-Fi devices typically have a switching overhead or delay of up to 100 ms. Therefore, MLO may be highly desirable for real-time applications like video calls, wireless VR headsets, cloud gaming and other latency-sensitive applications.

In some embodiments, a station (STA) in communication with an AP can receive downlink data from the AP while also receiving or generating low latency (LL) traffic. In some embodiments, the LL traffic can refer to data packets that are designed to travel between devices with minimal delay (e.g., with low latency). Ensuring timely transmission of the LL traffic can be especially critical for the real-time applications like video calls, wireless VR headsets, cloud gaming and other latency-sensitive applications. Typically, a STA receiving the LL traffic has to wait until an end of a transmit opportunity (TXOP) or an end of a physical layer protocol data unit (PPDU) transmission, in order to request an opportunity to transmit the LL traffic it received. However, long TXOP durations or long PPDU data transmissions can cause delay in transmitting the LL traffic in a timely manner, increasing the overall latency of the system.

In order to combat this issue, the AP may transmit the PPDU in divided segments (e.g., D-PPDUs). Each divided PPDU can be transmitted after a given time interval, providing an STA receiving LL traffic an opportunity to send a frame request to the AP in order to transmit its LL traffic.

However, multiple STAs within a Basic Service Set (BSS) serviced by the AP may receive LL traffic simultaneously or around a same time. This can include STAs that are TXOP responders, e.g., STAs that are already in communication with the AP and receiving the DL traffic. The BSS can also include STAs that are not TXOP responders and are not already in communication with the AP. However, in typical Wi-Fi systems, both the STA that is a TXOP responder and the STA that is not a TXOP responder wait until an end of a divided PPDU transmission, before initiating their count of a short interframe space (SIFS). Since each SIFS is the same, both the STA that is a TXOP responder and the STA that is not a TXOP responder simultaneously transmit their preemption request frames to request an opportunity for transmission of their LL traffic.

In such examples, though, the AP may be unable to identify which PR frame belongs to which STA. Therefore, there may be scenarios in which the AP enables the STA who is not a TXOP responder to transmit its LL traffic first. This may cause fairness issues and also reduce the overall efficiency of the system. That is, it may be less efficient in terms of medium utilization to allow the STA, who is not the TXOP responder, to transmit its LL traffic before the STA that is already a TXOP responder. Accordingly, existing solutions often fail to address the prioritization of a given STA during preemption operations. Therefore, a need exists for a method to optimize preemption operations through prioritization mechanisms.

The description set forth in the background section should not be assumed to be prior art merely because it is set forth in the background section. The background section may describe aspects or embodiments of the present disclosure.

### SUMMARY

Some aspects of this disclosure are directed to improvements for prioritization in a preemption operation.

In some embodiments, a station (STA) in a wireless network can include a memory and a processor coupled to the memory, where the processor is configured to cause receiving, from an access point (AP), a downlink frame including information indicating a reference point in the downlink frame, transmitting a preemption request frame after a predetermined interframe space has elapsed from the reference point in the downlink frame when the STA has low latency traffic to transmit, and transmitting an uplink frame including the low latency traffic after transmitting the preemption request frame.

In some embodiments, the reference point is at a start of a padding field of the downlink frame.

In some embodiments, the information is located in a medium access control (MAC) header or in a signal field of the downlink frame.

In some embodiments, the processor is further configured to cause receiving, from the AP, an acknowledgement responsive to transmitting the uplink frame including the low latency traffic and receiving, from the AP, another downlink frame after receiving the acknowledgement.

In some embodiments, the reference point is before an end of the downlink frame.

In some embodiments the reference point is at an end of the downlink frame.

In some embodiments, the reference point indicates a specific point in the downlink frame at which to initiate a count for the predetermined interframe space.

In some embodiments, an access point (AP) in a wireless network includes a memory and a processor coupled to the memory, the processor configured to cause obtaining a transmit opportunity to transmit downlink data, transmitting, to a station (STA), a downlink frame including information indicating a reference point in the downlink frame, receiving a preemption request frame after a predetermined interframe space has elapsed from the reference point in the downlink frame indicating the STA has low latency traffic to transmit, and receiving an uplink frame including the low latency traffic after receiving the preemption request frame.

In some embodiments, the processor is further configured to cause pausing transmission of the downlink data based at least in part on receiving the preemption request and transmitting a second downlink frame and resume transmission of the downlink data after receiving the LL traffic.

In some embodiments, the reference point is at a start of a padding field of the downlink frame.

In some embodiments, the AP is in a basic service set (BSS) including the STA that is a transmit opportunity responder and a second STA that is not a transmit opportunity responder, wherein the second STA is configured to cause receiving second low latency traffic at a buffer in a memory of the second STA, initiating a count for the predetermined interframe space after the transmission of the downlink frame, and determining a medium coupled to the AP, the STA, and the second STA is busy based on initiating the count for the predetermined interframe space after transmission of the downlink frame.

In some embodiments, the reference point is before an end of the downlink frame.

In some embodiments, the reference point is at an end of the downlink frame.

In some embodiments, a method performed by a station (STA) in a wireless network includes receiving, from an access point (AP), a downlink frame including information indicating a reference point in the downlink frame, transmitting a preemption request frame after a predetermined interframe space has elapsed from the reference point in the downlink frame when the STA has low latency traffic to transmit, and transmitting an uplink frame including the low latency traffic after transmitting the preemption frame request.

In some embodiments, the reference point is at a start of a padding field of the downlink frame.

In some embodiments, the information is located in a medium access control (MAC) header or in a signal field of the downlink frame.

In some embodiments, the method further includes receiving, from the AP, an acknowledgment responsive to transmitting the uplink frame including the low latency traffic and receiving, from the AP, another downlink frame after receiving the acknowledgement.

In some embodiments, the reference point is before an end of the downlink frame.

In some embodiments, the reference point is at an end of the downlink frame.

In some embodiments, the reference point indicates a specific point in the downlink frame at which to initiate a count for the predetermined interframe space.

Prioritization of one station (STA) over another STA for low latency (LL) traffic transmission during preemption operations can provide for more efficient utilization of a channel medium.

The prioritization of preemption operations as described herein can ensure that a station (STA) already in an ongoing communication session with an AP can efficiently extend its transmission to include the LL traffic without unnecessary delays.

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4A illustrates the EHT MU PPDU format in accordance with an embodiment.

FIG. 4B illustrates the EHT TB PPDU format in accordance with an embodiment.

FIG. 5 shows the MLO operation with two links in accordance with an embodiment.

FIG. 6 illustrates a PPDU transmission procedure in accordance with an embodiment.

FIG. 7 illustrates a preemption operation in accordance with an embodiment.

FIG. 8 illustrates a preemption operation with divided PPDUs in accordance with an embodiment.

FIG. 9 illustrates a preemption operation with divided PPDUs in accordance with an embodiment.

FIG. 10 illustrates a prioritization scheme in accordance with an embodiment.

FIG. 11 illustrates a prioritization preemption operation in accordance with an embodiment.

FIG. 12 illustrates a PPDU format in accordance with an embodiment.

FIG. 13 illustrates a prioritization operation in accordance with an embodiment.

FIG. 14 illustrates a prioritization operation in accordance with an embodiment.

FIG. 15 illustrates a method for a prioritization operation in accordance with an embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA, a non-AP, or another network or computing device, may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

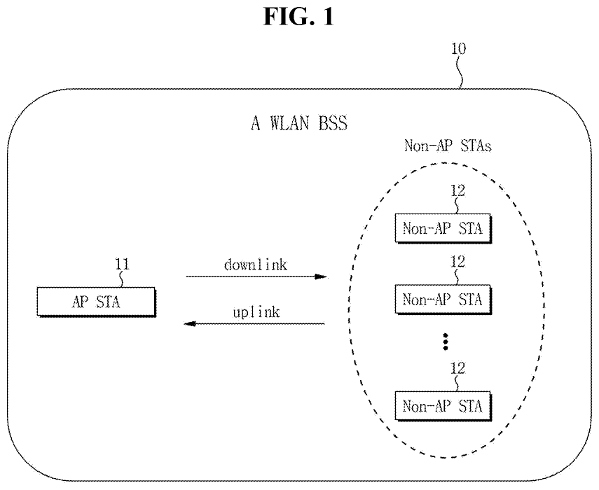

FIG. 1 illustrates a schematic diagram of an example wireless communication network. In some embodiments, FIG. 1 may illustrate wireless local network (WLAN).

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. In other embodiments, the BSS 10 can be considered composed of two kinds of entities, which are the single AP STA 11 and multiple non-AP STAs 12. In some embodiments, the STAs may share a same radio frequency channel with one out of WLAN operation bandwidth options (e.g., 20/40/80/160/320 megahertz (MHz)). Hereinafter, in some embodiments, the AP STA and the non-AP STA may be referred as AP and STA, respectively. In some embodiments, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources. For example, the MU transmission can mean that frames in a certain BSS are transmitted to (DL MU) or from (UL MU) multiple STAs simultaneously based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission. For example, the MU-MIMO transmission could be with DL-OFDMA, DL-MU-MIMO, UL-OFDMA, and UL-MU-MIMO of MU transmission.

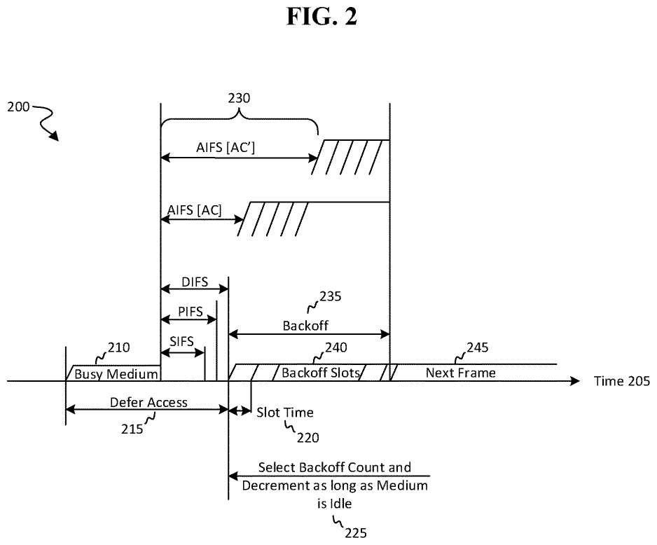

FIG. 2 illustrates an example of a timing diagram of interframe space (IFS) relationships between stations in accordance with an embodiment. In an embodiment multi-user access modulation (e.g., OFDMA), for both uplink and downlink, has been introduced since High Efficiency (HE) WLAN (e.g., IEEE 802.11ax standard). In one embodiment, after future amendments to the standard (e.g., such as Extreme High Throughput (EHT)), one or more STAs are allowed to use one or more resource units (RUs) throughout operation bandwidth and also transmit at the same time. In one embodiment, one RU is a minimum granularity which can be assigned and has decades of subcarriers in OFDM modulation symbols. In such embodiments, non-AP STAs could be associated or non-associated with an AP STA when responding simultaneously in the assigned RUs within a specific period (e.g., within a short inter frame space (SIFS). In some embodiments, a SIFS is the time from the end of the last symbol, or signal extension if present, of the previous frame to the beginning of the first symbol of the preamble of the subsequent frame. For example, if the control frame is a response frame of a previous frame, the WLAN device transmits the control frame without performing a backoff during period 235 if a SIFS has elapsed during a period 230 shown in FIG. 2.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred during period 215 while the medium is busy 210 until a type of IFS duration 230 has elapsed. In an embodiment, a type of IFS may be determined based on a type of STA or based on a type of frame transmitted or received.

The STA may transmit the data frame during a next frame 245 after performing backoff after a period 235 if a distributed coordination function IFS (DIFS) has elapsed from a time when the medium has been idle by selecting a backoff count and decrement as long as the medium is idle starting at a time 225.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff during period 235 if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS[AC] or AIFS[AC′] has elapsed. In this case, the data frame, the management frame, or the control frame which is not the response frame may use the AIFC[AC].

In some embodiments, a point coordination function (PCF) enabled AP STA may transmit the frame after performing backoff if a PCF IFS (PIFS) has elapsed. The PIFS duration may be less than the DIFS but greater than the SIFS. In some embodiments, the backoff period 235 can include one or more backoff slots 240.

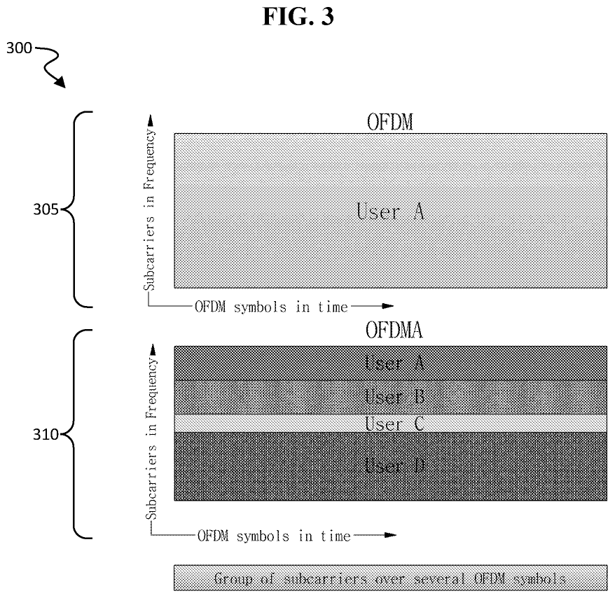

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUS) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3. That is, an OFDM scheme 305 can include a User A as a subcarrier in the frequency while the OFDMA scheme 310 can include Users A-D as subcarriers in the frequency.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP.

The trigger frame may have STA's information and assign RUs and multiple RUS (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

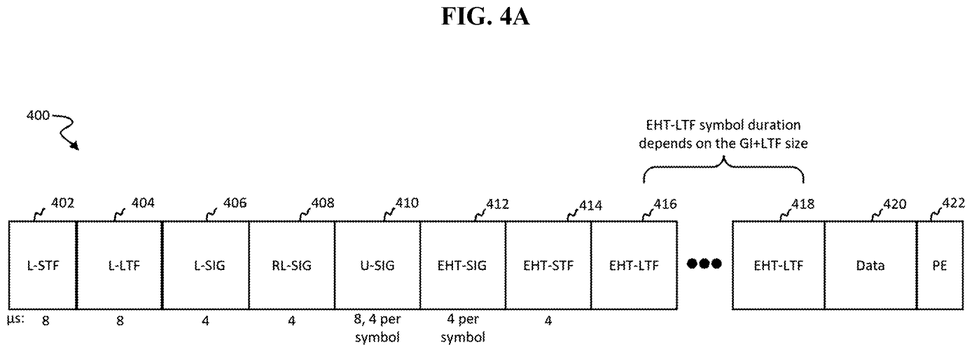

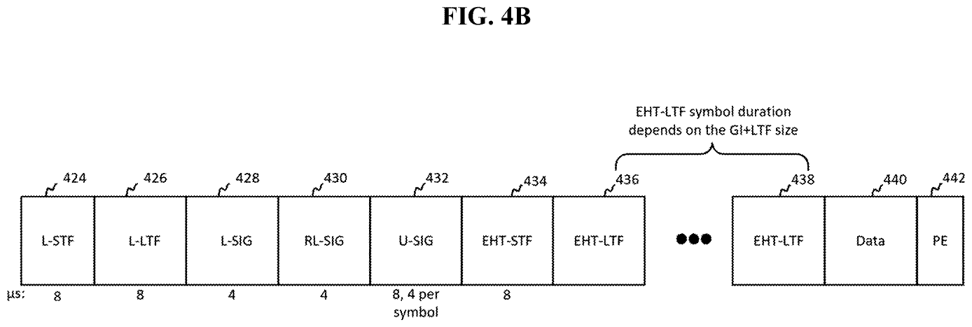

In the EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A illustrates the EHT MU PPDU format in accordance with an embodiment.

The EHT MU PPDU may be used for transmission to one or more users—e.g., for both single user transmission and multiple user transmission. The EHT MU PPDU is not a response to a triggering frame. In one embodiment, for the EHT MD PPDU the EHT-SIG (signal) field 412 is present as described below.

Referring to FIG. 4A, the EHT MU PPDU may include, or consist of, an EHT preamble (hereinafter referred to as a PHY preamble or a preamble), a data field 420, and a packet extension (PE) field 422. The EHT preamble may include, or consist of, pre-EHT modulated fields and EHT modulated fields. The pre-EHT modulated fields may include, or consist of, a Non-HT short training field (L-STF) 402, a Non-HT long training field (L-LTF) 404, a Non-HT signal (L-SIG) field 406, a repeated Non-HT signal (RL-SIG) field 408, a universal signal (U-SIG) field 410, and an EHT signal (EHT-SIG) field 412. The EHT modulated fields may include, or consist of, an EHT short training field (EHT-STF) 414 and an EHT long training field (EHT-LTF) 416-418. In some embodiments, the L-STF 402 may be immediately followed by the L-LTF 404 immediately followed by the L-SIG field 406 immediately followed by the RL-SIG field 408 immediately followed by the U-SIG field 410 immediately followed by the EHT-SIG field 412 immediately followed by the EHT-STF 414 immediately followed by the EHT-LTF 416-418 immediately followed by the data field 420 immediately followed by the PE field 422 as illustrated in FIG. 4A. However, other structures or orders of the fields of the EHT MU PPDU are possible.

The L-STF field 402 may be utilized for packet detection, automatic gain control (AGC), and coarse frequency-offset correction.

The L-LTF field 404 may be utilized for channel estimation, fine frequency-offset correction, and symbol timing.

The L-SIG field 406 may be used to communicate rate and length information.

The RL-SIG field 408 may be a repeat of the L-SIG field 406 and may be used to differentiate an EHT PPDU from a non-HT PPDU, HT PPDU, and VHT PPDU.

The U-SIG field 410 may carry information necessary to interpret EHT PPDUs.

The EHT-SIG field 412 may provide additional signaling to the U-SIG field 410 for STAs to interpret an EHT MU PPDU. Hereinafter, the U-SIG field 410, the EHT-SIG field 412, or both may be referred to as the SIG field.

The EHT-SIG field 412 may include one or more EHT-SIG content channels. Each of the one or more EHT-SIG content channels may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a number of spatial streams (NSS) subfield, a beamformed subfield, and a coding subfield. The user field for a MU-MIMO allocation may include a STA-ID subfield, a MCS subfield, a coding subfield, and a spatial configuration subfield.

The EHT-STF field 414 may be used to improve automatic gain control estimation in a MIMO transmission.

The EHT-LTF field 416-418 may enable the receiver to estimate the MIMO channel between the set of constellation mapper outputs and the receive chains. In some embodiments, the EHT-LTF field 416-418 symbol duration can depend on a size of a guard interval (GI)+LTF size.

The data field 420 may carry one or more physical layer convergence procedure (PLCP) service data units (PSDUs).

The PE field 422 may provide additional receive processing time at the end of the EHT MU PPDU.

FIG. 4B illustrates the EHT TB PPDU format in accordance with an embodiment.

The EHT TB PPDU may be used for a transmission that is a response to a triggering frame from an AP. In one embodiment, in the EHT TB PPDU, the EHT-SIG field 412 is not present and a duration of the EHT-STF field 434 is twice the duration of the EHT-STF field 414 in the EHT MU PPDU.

Referring to FIG. 4B, the EHT TB PPDU may include, or consist of, an EHT preamble (hereinafter referred to as a PHY preamble or a preamble), a data field 440, and a packet extension (PE) field 442. The EHT preamble may include, or consist of, pre-EHT modulated fields and EHT modulated fields. In an embodiment, the pre-EHT modulated fields are sent only on 20 megahertz (MHz) channels where a station's EHT modulated fields are present. In such embodiments, if the station's modulated fields occupy more than one 20 MHz channel, the pre-EHT modulated fields are duplicated over multiple 20 MHz channels. The pre-EHT modulated fields may include, or consist of, a Non-HT short training field (L-STF) 424, a Non-HT long training field (L-LTF) 426, a Non-HT signal (L-SIG) field 428, a repeated Non-HT signal (RL-SIG) field 430, and a universal signal (U-SIG) field 432. The EHT modulated fields may include, or consist of, an EHT short training field (EHT-STF) 434 and an EHT long training field (EHT-LTF) 436. In some embodiments, the L-STF 424 may be immediately followed by the L-LTF 426 immediately followed by the L-SIG field 428 immediately followed by the RL-SIG field 430 immediately followed by the U-SIG field 432 immediately followed by the EHT-STF 434 immediately followed by the EHT-LTF 436-438 immediately followed by the data field 440 immediately followed by the PE field 442. In the EHT TB PPDU, the EHT-SIG field is not present because the trigger frame conveys necessary information.

The below table (table 1) further summarizes the EHT PPDU format of the frame.

TABLE 1

| Field | Description |
|---|---|
| L-STF | Non-HT Short Training field |
| L-LTF | Non-HT Long Training field |
| L-SIG | Non-HT SIGNAL field |
| RL-SIG | Repeated Non-HT SIGNAL field |
| U-SIG | Universal SIGNAL field |
| EHT-SIG | EHT SIGNAL field |
| EHT-STF | EHT Short Training field |
| EHT-LTF | EHT Long Training field |
| Data | The Data field carrying the PSDU(s) |
| PE | Packet extension field |

Description for each field in the EHT TB PPDU will be omitted because description for each field in the EHT MU PPDU is applicable to the EHT TB PPDU.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in a medium access control (MAC) layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHz and 6 GHz.

There exists Wi-Fi technologies that allow a Wi-Fi device to connect to a single link and enable the Wi-Fi device to switch among 2.4 GHz, 5 GHz and 6 GHz bands. However, such Wi-Fi devices typically have a switching overhead or delay of up to 100 ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

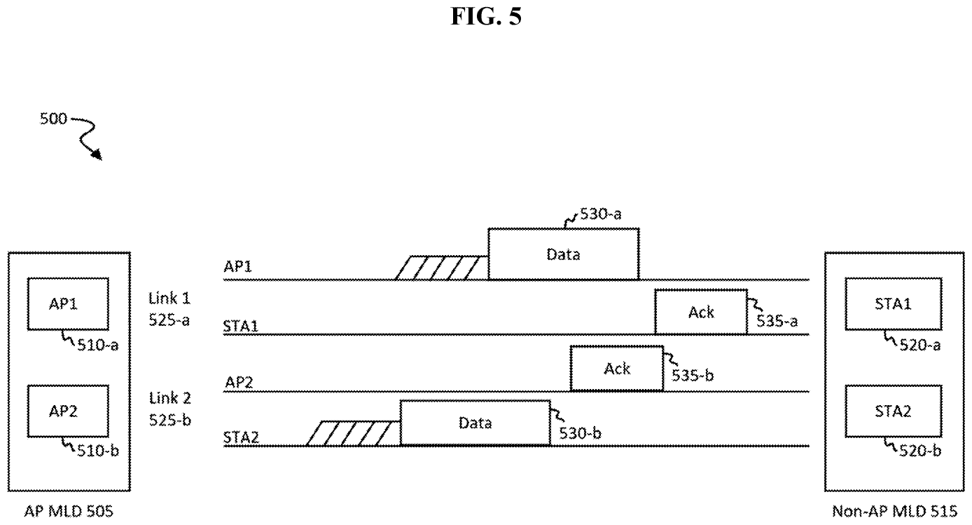

Hereinafter, a Multi-link Operation (MLO) will be described with reference to FIG. 5. FIG. 5 shows the MLO operation with two links (e.g., link 525-a and link 525-b) in accordance with an embodiment. In an embodiment, FIG. 5 illustrates an AP MLD 505 comprising a plurality of APs including AP1 510-a and AP2 510-b couple via link 525-a and link 525-b to a non-AP MLD 515. In an embodiment, the non-AP MLD 515 comprises a plurality of STAs including STA1 520-a and STA2 520-b.

The AP 1 510-a may have a buffer containing data units including data units to be transmitted to the STA 1 520-a, the AP 2 510-b may have a buffer containing data units including data units to be transmitted to the STA 2 520-b, the STA 1 520-a may have a buffer containing data units including data units to be transmitted to the AP 1 510-a, and the STA 2 520-b may have a buffer containing data units including data units to be transmitted to the AP 2 510-b.

The STA 2 520-b of the non-AP MLD 515 may check whether a backoff counter for the link 525-b (L2) reaches 0. When the backoff counter for the link 525-b (L2) reaches 0, the STA 2 520-b of the non-AP MLD 515 may transmit the data unit 530-b to the AP 2 510-b via the link 525-b (L2). The AP 2 510-b of the AP MLD 505 may transmit an Ack frame 535-b for the data unit 530-b to the STA 2 520-b via the link 525-b (L2) during a SIFS after the AP 2 510-b successfully receives the data unit 530-b.

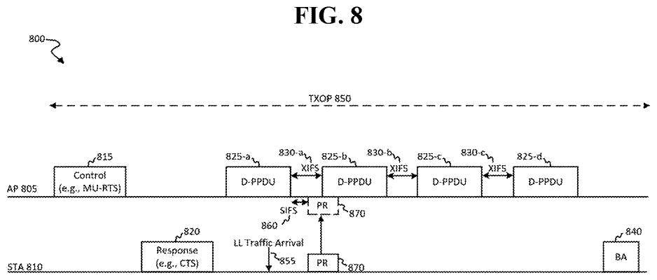

Even during the AP 2's 510-b reception of the data unit 530-b, the AP 1 510-a of the AP MLD 505 may check whether a backoff counter for the link 525-a (L1) reaches 0. When the backoff counter for the link 525-a (L1) reaches 0, the AP 1 510-a of the AP MLD 505 may transmit the data unit 530-a to the STA 1 520-a via the link 525-a (L1) even during the AP 2's 510-b reception of the data unit 535-b. The STA 1 520-a of the non-AP MLD 515 may transmit an Ack frame 535-a for the data unit 530-a to the AP 1 510-a via link 525-a (L1) during a SIFS after the STA 1 520-a successfully receives the data unit 530-a. In the embodiment of FIG. 8, the AP MLD 505 may complete receiving the data 530-b via the link 525-b (L2) first, and then the non-AP MLD 515 may complete receiving the data unit 530-a via the link 525-a L1.

Hereinafter, a physical layer protocol data unit (PPDU) transmission procedure implemented in current Wi-Fi systems is described.

For Wi-Fi systems, there have been a lot of efforts to improve latency. Specifically, efforts to improve latency for latency sensitive traffic. For example, preemption operations have been considered as one possible technique to improve latency and support low latency applications/traffic. The present disclosure is directed to improved preemption operations in which each STA operates with an assigned priority for the preemption. That is, the preemption prioritization described herein helps to deal with low latency traffic in an efficient manner.

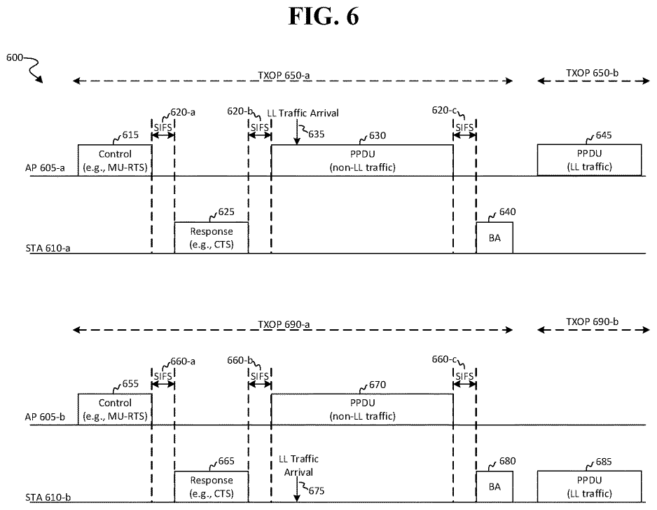

Referring to FIG. 6, the PPDU transmission procedure 600 is performed between an AP 605 and an STA 610. In an embodiment, when either the AP 605 or the STA 610 receive low latency (LL) traffic while already being engaged in transmitting or receiving non-low latency traffic during a transmit opportunity (TXOP) duration, the AP 605 or the STA 610 have to wait until an end of the TXOP. In such embodiments, the AP 605 and STA 610 have to wait until the end of the TXOP even if the desired goal is to transmit the LL traffic as quickly as possible.

For example, an AP 605-a can transmit a control frame 615 (e.g., a multi-user request to send (MU-RTS)) and receive a response 625 (e.g., clear to send (CTS)) from the STA 610-a after a first short interframe space (SIFS) 620-a elapses. In such examples, the AP 605-a can transmit a PPDU (e.g., non-LL traffic) 630 after the elapse of a second SIFS 620-b. In one embodiment, while the AP 605-a is transmitting the PPDU 630, the AP 605-a receives LL traffic 635 (e.g., the LL traffic is engaged in the AP 605-a buffer). However, the AP 605-a cannot transmit the LL traffic 635 until the end of the current TXOP 650-a. That is the AP 605-a proceeds to transmit the remaining bits of the PPDU 630, receives a block acknowledgment (BA) frame 640 from the STA 610-a after an elapse of a third SIFS 620-c, and then proceeds to contend for channel access again to get a new TXOP 650-b. If the AP 605-a successfully obtains the TXOP 650-b, the AP 605-a can then transmit PPDU 645 including the LL traffic.

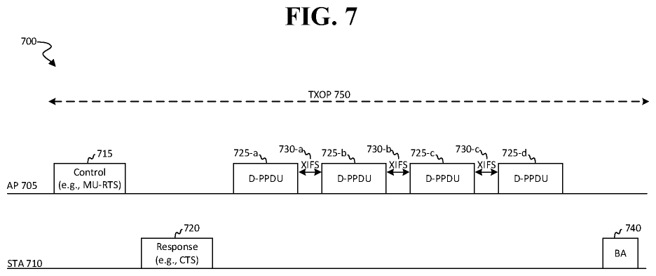

Similarly, the STA 610-b also cannot transmit the LL traffic until an end of a current TXOP. For example, the AP 605-b can transmit a control frame 655 (e.g., a multi-user request to send (MU-RTS)) and receive a response 665 (e.g., clear to send (CTS)) from the STA 610-b after a first short interframe space (SIFS) 660-a elapses. In such examples, the AP 605-b can transmit a PPDU (e.g., non-LL traffic) 670 after the elapse of a second SIFS 660-b. In one embodiment, while the AP 605-b is transmitting the PPDU 630, the STA 610-b receives LL traffic 675 (e.g., the LL traffic is engaged in the STA 610-b buffer). However, the STA 610-b cannot transmit the LL traffic 675 until the end of the current TXOP 690-a. That is the STA 610-b proceeds to wait as the AP 605-b transmits the remaining bits of the PPDU 670, and then transmits a block acknowledgment (BA) frame 680 to the AP 610-b after an elapse of a third SIFS 660-c. In such embodiments, the STA 610-b then proceeds to contend for channel access again to get a new TXOP 690-b. If the STA 610-b successfully obtains the TXOP 690-b, the STA 610-b can transmit PPDU 685 including the LL traffic. However, this procedure (e.g., transmission procedure 600) that is currently implemented in the Wi-Fi system has an issue in that as the length of the PPDU including non-LL traffic increases the performance of latency decreases. That is, the longer the PPDU, the longer the AP 605 or STA 610 have to wait before they can transmit the LL traffic. Therefore, to solve this issue, a preemption operation described with reference to FIG. 7 is considered.

Hereinafter, a preemption operation 700 will be described with reference to FIG. 7.

In an embodiment, the preemption operation is performed between an AP and an STA (e.g., AP 705 and STA 710). In some embodiments, when an AP 705 or STA 710 transmits a long data PPDU, the large PPDU is divided into smaller PPDUs with a maximum length limitation and time gaps to enable preemption opportunities for low latency (LL) transmissions.

For example, after AP 705 transmits an initial control frame 715 (e.g., MU-RTS) and the STA 710 transmits a response frame 720 (e.g., CTS) to the control frame 715, the AP 705 can transmit a PPDU frame that is divided into smaller PPDUs (e.g., divided PPDUs (D-PPDU 725)). As illustrated in the preemption operation 700, the AP 705 can transmit the PPDU in four (4) parts as D-PPDU 725-a, D-PPDU 725-b, D-PPDU 725-c, and D-PPDU 725-d where each subsequent D-PPDU 725 after the first D-PPDU 725 is transmit after a period XIFS 730 (e.g., where XIFS is a constant interval). That is, the AP 705 can transmit D-PPDU 725-b after an XIFS 730-a, D-PPDU 725-c after an XIFS 730-b, and D-PPDU 725-d after an XIFS 730-c. The STA 710 can transmit a BA frame 740 to acknowledge reception of the D-PPDU frames 725.

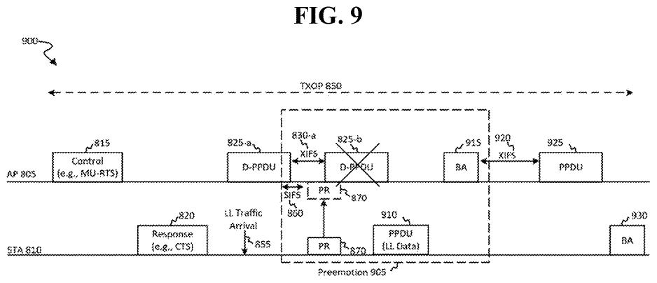

In an embodiment, a large PPDU can be divided into multiple smaller D-PPDUs 725 with transmission intervals longer than a typical SIFS interval in anticipation of LL traffic—e.g., in anticipation of LL traffic generated at the STA 710 where the XIFS interval is greater than the SIFS interval. In such embodiments, the STA 710 can have an opportunity to transmit the generated LL traffic in the middle of a PPDU transmission without having to wait until the TXOP duration 750 ends or a large PPDU transmission is completed as described with reference to FIG. 6. For example, FIGS. 8 and 9 illustrate a scenario in which the STA generates LL traffic and transmits the LL traffic without having to wait for the completion of a TXOP or a transmission of a large PPDU.

FIG. 8 illustrates an AP 805 transmitting divided PPDUs (D-PPDU) 825 during a TXOP 850 after transmitting a control frame 815 and receiving a response frame 820 from the STA 810. In one embodiment, the STA 810 can receive LL traffic e.g., generate LL traffic) while the transmission of the D-PPDUs 825 is ongoing. For example, the STA 810 can receive LL traffic 855 while the first D-PPDU 825-a is being transmitted. In such embodiments, if the STA 810 wants to transmit the LL traffic 855, the STA can transmit a preemption request (PR) frame 870 within the XIFS interval 830-a (e.g., after an SIFS interval 860 elapses following the transmission of D-PPDU 825-a). That is, the XIFS interval 830 can be greater than the SIFS interval 860 to allow the STA 810 to transmit PR 870 frames. Accordingly, the STA 810 can transmit the PR 870 frame before the transmission of the second D-PPDU 825-b.

In embodiments where the STA 810 transmits the PR frame 870, the STA 810 can start contending by ignoring the network allocation vector (NAV) set by the AP 805 in either the control frame 815 or the response frame 820.

As illustrated with reference to FIG. 9, during the preemption process 905, when the STA 810 transmits the PR frame 870 before the transmission of the second D-PPDU 825-b, the AP 805 can receive the frame and prepare for the LL traffic 855. That is, the AP 805 will forego transmission of the second D-PPDU 825-b and instead will prepare to receive the LL traffic 855 that the STA 810 intends to transmit.

Accordingly, after contending for channel access and winning, the STA 810 can transmit a PPDU 910 that includes the LL traffic to the AP 805. Upon receiving the LL traffic 855, the AP 805 can transmit a BA 915 in response. Following the transmission of the BA 915, the AP 805 can then resume transmission of the non-LL traffic PPDU after a XIFS 920 (e.g., transmit PPDU 925). In some embodiments, the PPDU 925 can be a long PPDU. In other embodiments, the PPDU 925 starts with the transmission of the D-PPDU 825-b, and then after an XIFS interval, the transmission of D-PPDU 825-c, and so forth, as illustrated in FIG. 8.

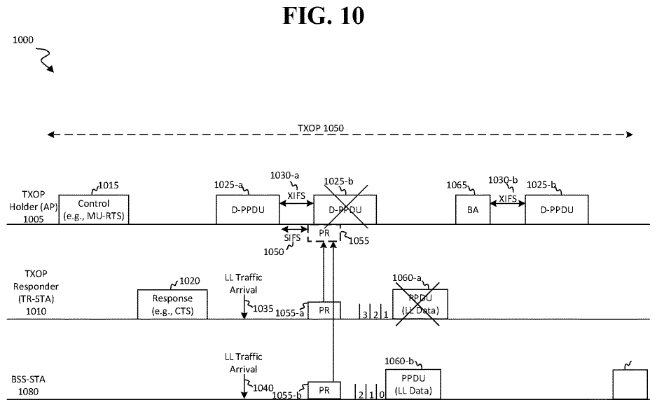

Hereinafter, a prioritization scheme 1000 will be described with reference to FIG. 10.

In an embodiment, when an AP becomes a TXOP holder (e.g., AP 1005) through channel contention, the STAs that participate in the preemption operation can be one of two types. The first type is an STA which is the TXOP responder to whom the TXOP holder AP 1005 intends to send data. The second type is an STA which is within the same BSS that is associated with the TXOP holder AP 1005 but said STA is not a TXOP responder. For the sake of clarity, the TXOP responder STA of the first type will be referred to as a TXOP responder station (TR-STA 1010) and the STA of the second type that is in the same BSS but not the TXOP responder will be referred to as a BSS-STA (e.g., BSS-STA 1080).

In one embodiment, as illustrated in FIG. 10, during the TXOP duration 1050, the TXOP holder AP 1005 may be transmitting downlink data while multiple STAs in the same BSS might have LL traffic arriving in their buffers. For example, after the TXOP holder AP 1005 transmits a control frame 1015 (e.g., MU-RTS) and the TR-STA 1010 transmits a response frame 1020 (e.g., CTS), the TXOP holder AP 1005 can begin transmitting downlink data in the form of a first D-PPDU 1025-a. However, in one embodiment, the TR-STA 1010 will have LL traffic 1035 (e.g., LL traffic 1035 arrives from an upper layer) around the same time that the BSS-STA 1080 also has LL traffic 1040. In such embodiments, the TR-STA 1010 and the BSS-STA 1080 will simultaneously transmit PR frame 1055-a and PR frame 1055-b, respectively. That is, both the TR-STA 1010 and the BSS-STA 1080 will wait until the AP finishes transmitting the first D-PPDU 1025-a, and transmit their respective PR frames 1055 after the SIFS 1050.

However, when the TR-STA 1010 and the BSS-STA 1080 simultaneously transmit PR frame 1055-a and PR frame 1055-b, the TXOP holder AP 1005 cannot identify which STA is trying to send LL traffic (e.g., the TXOP holder AP 1005 may be unable to distinguish whether the TR-STA 1010, BSS-STA 1080, or both are trying to send LL traffic).

Because the TXOP holder AP 1005 is unable to identify which STA is trying to send the traffic, both the TR-STA 1010 and the BSS-STA 1080 (e.g., the STAs that transmitted a PR frame) compete for channel access to get an opportunity to transit their respective LL traffic. In the embodiment shown in FIG. 10, the BSS-STA 1080 gains channel access before the TR-STA 1010. Accordingly, the TXOP holder AP 1005 refrains from transmitting the second D-PPDU 1025-b and instead enables the BSS-STA 1080 to transmit PPDU 1060-b with the LL traffic 1040 to the TXOP holder AP 1005 while the TR-STA 1010 is unable to transmit PPDU 1060-a with its LL traffic 1035. The TXOP holder AP 1005 then proceeds to transmit a BA 1065 and resumes transmitting the downlink data by transmitting the second D-PPDU 1025-b.

However, in this embodiment, fairness issues may arise since the TR-STA 1010 is included among the STAs that simultaneously transmit PR frames 1055. In such embodiments, the effectiveness of the preemption operation may decrease. That is, since the TR-STA 1010 is already qualified to send and receive data with the TXOP holder AP 1005 during the TXOP 1050 duration, it is more efficient, in terms of medium utilization, for the TR-STA 1010 to have the opportunity to transmit its LL traffic 1035 before the BSS-STA 1080 transmits its LL traffic 1040. For example, the TR-STA 1010 can transmit the LL traffic 1035 as an extension of the already ongoing communication between the TXOP holder AP 1005 and the TR-STA 1010 during the TXOP 1050 duration. Accordingly, the present disclosure describes a method of prioritization for the preemption operation.

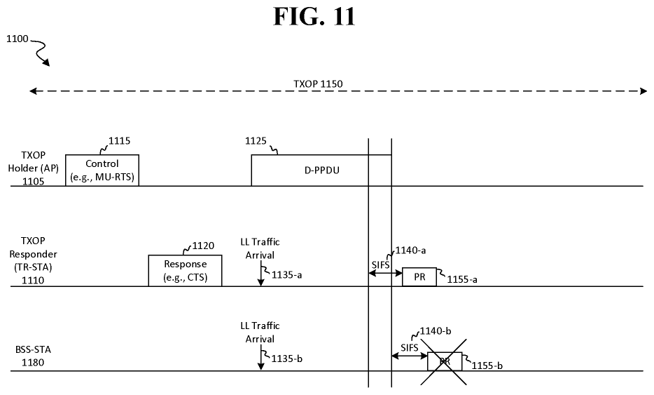

Hereinafter, a prioritization preemption operation 1100 will be described with reference to FIG. 11.

In an embodiment, the prioritization preemption operation 1100 is implemented in a system that includes a TXOP holder AP 1105, a TXOP responder (TR-STA) 1110, and a BSS-STA 1180. In one embodiment, while the TXOP holder AP 1105 is transmitting downlink traffic, both the TR-STA 1110 and the BSS-STA 1180 may have LL traffic (e.g., LL traffic arrives from an upper layer) at or around a same time. For example, the TXOP holder AP 1105 may transmit a control frame 1115 (e.g., MU-RTS) to the TR-STA 1110, receive a response frame 1120 (e.g., CTS) from TR-STA 1110, and begin transmitting downlink traffic D-PPDU 1125 during a TXOP 1150 duration.

While the TXOP holder AP 1105 is transmitting the D-PPDU 1125, the TR-STA 1110 may receive LL traffic 1135-a (e.g., from an upper layer) while the BSS-STA 1180 may receive LL traffic 1135-b (e.g., from the upper layer). In order to prevent the BSS-STA 1180 from transmitting its LL traffic 1135-b first, as described with reference to FIG. 10, the present disclosure provides a prioritization scheme. For example, when the TR-STA 1110 and the BSS-STA 1180 receive LL traffic 1135-a and LL traffic 1135-b, respectively, the TR-STA 1110 that is already engaged in communication with the TXOP holder AP 1110 during the TXOP 1150 duration, can be prioritized for LL traffic transmission in order to ensure efficient medium utilization. In such examples, the TXOP holder AP 1105 can implement a mechanism to recognize and prioritize the TR-STA 1110 PR frame 1155-a over the BSS-STA 1180 PR frame 1155-b. This ensures that the TR-STA 1110, which is already in an ongoing communication session during the TXOP 1150 duration, can efficiently extend its transmission to include the LL traffic 1135-a without unnecessary delays.

As illustrated in FIG. 11, the TR-STA 1110 transmits its PR frame 1155-a before the BSS-STA 1180 transmits its PR frame 1155-b. That is, in the preemption operation described with reference to FIG. 10, both the TR-STA 1010 and the BSS-STA 1080 receive their respective LL traffic and wait until an end of the TXOP holder AP's 1005 D-PPDU transmission (e.g., transmission of D-PPDU 1025-a) before transmitting their respective PR frames 1055. However, in the prioritization preemption operation 1100 described herein, the TR-STA 1110 is permitted to start counting its SIFS interval 1140-a from a specific midpoint during the D-PPDU 1125 transmission. Because the TR-STA 1110 is able to start counting its SIFS 1140-a before the BSS-STA 1180 counts its SIFS 1140-b, the TR-STA 1110 is able to transmit its PR frame 1155-a before the BSS-STA 1180 can transmit its PR frame 1155-b.

In such an embodiment, when the TR-STA 1110 transmits its PR frame 1155-a first, the BSS-STA 1180 is unable to transmit its PR frame 1155-b because it detects that the channel is already busy. Accordingly, the prioritization preemption operation 1100 enables the TR-STA 1110 to gain priority to transmit its LL traffic 1135-a faster than the BSS-STA 1180.

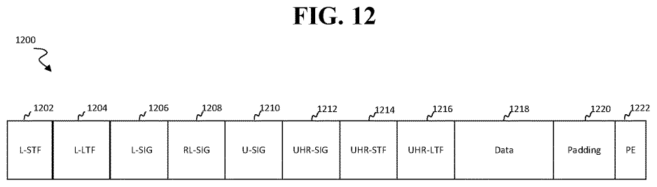

FIGS. 12-14 describe the specific midpoint in the D-PPDU 1125 at which the TR-STA 1110 can start counting SIFS 1140-a.

For example, FIG. 12 illustrates an example D-PPDU frame 1200—e.g., the TXOP holder AP 1105 can transmit the D-PPDU 1125 having a format equivalent to D-PPDU frame 1200. In an embodiment, the D-PPDU frame 1200 can include a Non-HT short training field (L-STF) 1202, a Non-HT long training field (L-LTF) 1204, a Non-HT signal (L-SIG) field 1206, a repeated Non-HT signal (RL-SIG) field 1208, a universal signal (U-SIG) field 1210, a ultra-high reliability (UHR) signal (UHR-SIG) field 412, a UHR short training field (UHR-STF) 1214 and a UHR long training field (EHT-LTF) 1216. The D-PPDU frame 1200 can also include a data frame 1218, a padding frame 1220, and a packet extension (PE) 1222. In some embodiments, the L-STF 1202 may be immediately followed by the L-LTF 1204 immediately followed by the L-SIG field 1206 immediately followed by the RL-SIG field 1208 immediately followed by the U-SIG field 1210 immediately followed by the UHR-SIG field 1212 immediately followed by the UHR-STF 1214 immediately followed by the UHR-LTF 1216 immediately followed by the data frame 1218 immediately followed by the padding 1220, followed by the PE 1222 as illustrated in FIG. 12.

Description for each field in the D-PPDU 1200 will be omitted because the description for each field of the EHT MU PPDU and EHT TB PPDU, with reference to FIGS. 4A and 4B, is applicable for the D-PPDU 1200. In an embodiment, a difference between FIGS. 4A and 4B versus FIG. 12 is the D-PPDU 1200 includes UHR information rather than EHT information.

In one embodiment, when an AP is transmitting a PPDU as defined in FIG. 12, the AP can instruct a TR-STA to start counting SIFS from a beginning of the padding 1220 and PE 1222 fields of the PPDU for the PR frame transmission. For example, the AP can give the instructions by adding a one-bit (1-bit) indication in the U-SIG 1210 or the UHR-SIG 1212 fields to signal the TR-STA to transmit the PR frame after a SIFS from the start of the PPDU's padding 1220 field. In other embodiments, the AP can give the instruction by adding a one-bit (1-bit) indication in a MAC header of the data 1218 field to signal the TR-STA to transmit the PR frame after a SIFS from the start of the PPDU's padding 1220 field. In either embodiment, if the AP sets the bit indication to a one “1”, the TR-STA can transmit the PR frame after the SIFS from the start of the padding 1220 field. However, if the AP sets the indication to a zero “0”, the TR-STA can transmit the PR frame after the SIFS from an end of the whole PPDU (e.g., the same as the BSS-STA as described with reference to FIG. 10).

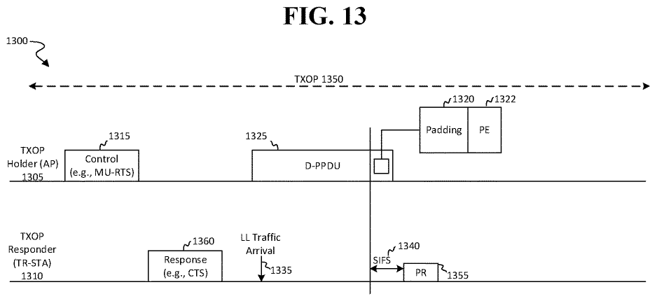

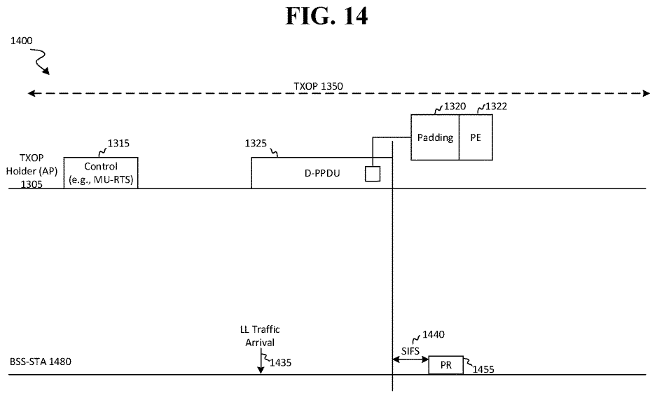

FIG. 13 and FIG. 14 illustrate the process for when a TR-STA and a BSS-STA transmit their PR frame for preemption when there is a bit indication as described herein.

For example, FIG. 13 illustrates a prioritization preemption operation 1300 between a TXOP holder AP 1305 and a TXOP responder (TR-STA) 1310. In an embodiment, during a TXOP 1350 duration, the TXOP holder AP 1305 can transmit a control frame 1315 (e.g., MU-RTS) to the TR-STA 1310. In such embodiments, the TR-STA 1310 can transmit a response 1360 frame (e.g., CTS) back to the TXOP holder AP 1305. Accordingly, the TXOP holder AP 1305 can begin transmission of D-PPDU 1325. In one embodiment, the D-PPDU 1325 includes a one-bit indication in, for example, either the U-SIG field, the UHR-SIG field, or in the MAC header of the data field. As described with reference to FIG. 13, the TXOP holder AP 1305 can set the one-bit indication to “1.”

Accordingly, when the TR-STA 1310 receives LL traffic 1335 from its upper layer during the transmission of the D-PPDU 1325, the TR-STA 1310 can begin counting its SIFS 1340 from a start of the padding 1320 and the PE 1322 fields. That is, because the one-bit indication is set to “1,” the TR-STA 1310 can start counting its SIFS 1340 before the end of the D-PPDU 1325 transmission, as described with reference to FIG. 12. Following the elapse of the SIFS 1340, the TR-STA 1310 can transmit its PR frame 1355.

On the other hand, as illustrated in FIG. 14, a BSS-STA 1480 would not begin counting its SIFS 1440 until after transmission of the D-PPDU frame 1325. That is, if the BSS-STA 1480 receives LL traffic 1435 from its upper layer during the TXOP 1350 duration, the BSS-STA 1480 will wait to transmit its PR frame 1455 until SIFS 1440 elapses, where the SIFS 1440 is counted from an end of the D-PPDU 1325 transmission.

Therefore, because the one-bit indication in D-PPDU 1325 is set to “one,” the TR-STA 1310 is able to get priority—e.g., the TR-STA 1310 would be able to transmit its PR frame 1355 before the BSS-STA 1480 as the TR-STA 1310 begins count of its SIFS 1340 before the padding 1320 and PE 1322 fields while the BSS-STA 1480 begins count of its SIFS 1440 after the padding 1320 and the PE 1322 fields.

It should be noted that in some embodiments, the LL traffic is received by the TXOP holder AP 1305 itself. In such embodiments, the TXOP holder AP 1305 can transmit the LL traffic in between transmissions of the D-PPDUs.

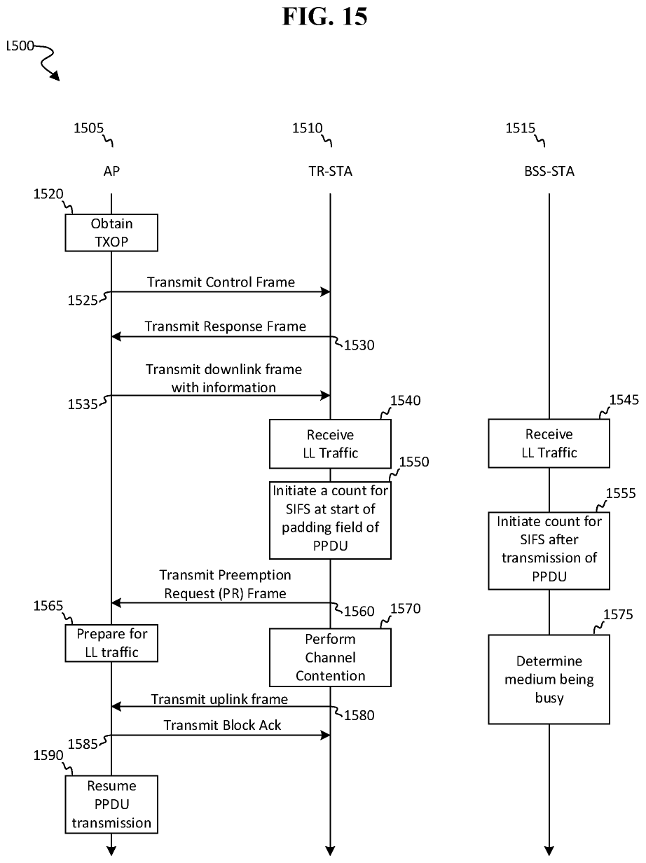

FIG. 15 shows a prioritization preemption procedure 1500 in accordance with an embodiment described herein.

Referring to FIG. 15, in one embodiment, the prioritization preemption procedure 1500 is performed by at least an AP 1505 (e.g., an example of a TXOP holder AP as described with reference to FIGS. 10-14), a TXOP responder (TR-STA) 1510 (e.g., an example of a TR-STA as described with reference to FIGS. 10-14), and a BSS-STA 1515 (e.g., an example of a BSS-STA described with reference to FIGS. 10-14) that is not a TXOP responder.

At operation 1520, the AP 1505 obtains a TXOP. In some embodiments, the AP 1505 obtains the TXOP to transmit downlink data to a STA that is a TXOP responder (e.g., to TR-STA 1510). In at least one embodiment, the AP 1505 can obtain the TXOP during a preemption operation. In such embodiments, the AP 1505 may transmit the downlink data in portions as described with reference to operation 1535. That is, the AP 1505 may transmit the DL data in one or more divided PPDUs (D-PPDU) where the PPDU at operation 1535 is a first divided PPDU.

At operation 1525, the AP 1505 transmits a control frame to the TR-STA 1510. In one embodiment, the control frame can include a multi-user request to send (MU-RTS). That is the control fame can include a trigger frame in order to eventually transmit the downlink information.

At operation 1530, the TR-STA 1510 can respond to the control frame by transmitting a response frame. In one embodiment, the response frame can include a clear to send (CTS).

At operation 1535, the AP 1505 can transmit a downlink data frame with information indicating a reference point in the downlink frame. That is, the AP 1505 can transmit a first PPDU based on receiving the response frame from the TR-STA 1510. In one embodiment, the AP 1505 transmits divided downlink frames (e.g., a divided PPDU (a D-PPDU as described with reference to FIG. 7)). That is, the AP 1505 can transmit a long PPDU as shorter D-PPDUs spaced at constant intervals (e.g., XIFS). By transmitting D-PPDUs, the AP 1505 can enable the TR-STA 1510 opportunities to transmit preemption request frames. In at least one embodiment, the downlink data includes information indicating a reference point in the downlink frame. In an embodiment, the information can be a bit indicator having a first value that indicates a specific point (e.g., the reference point) at which to initiate a count for a short interframe space (SIFS) (e.g., a predetermined interframe space) during the transmission of the PPDU for a preemption request when the TR-STA 1510 has low latency traffic to transmit.

In some embodiments, the bit indicator is a one-bit indication in either the U-SIG field, the UHR-SIG field (e.g., in a signal field), or in the MAC header of the data field that is set by AP 1505. In one embodiment, if the AP 1505 sets the bit indication to a one “1” (e.g., the first value), the TR-STA 1510 can transmit a PR frame after an SIFS from a start of a padding field rather than having to wait until the end of the first D-PPDU transmission—e.g., the reference point is at a start of a padding field of the downlink frame. However, if the AP 1505 sets the indication to a zero “0”, the TR-STA 1510 can transmit the PR frame after the SIFS from an end of the whole PPDU—e.g., the reference point is at an end of the downlink frame. Accordingly, the TR-STA 1510 can receive the first D-PPDU and determine a value of the one-bit indication. In such embodiments, if the TR-STA 1510 determines the one-bit indication has a first value (e.g., “1”) it can transmit a PR frame as described with reference to operation 1550. However, if the TR-STA 1510 determines the one-bit indication has a second value (e.g., “0”), it can transmit a PR frame in a same manner as the BSS-STA 1515 as described in operation 1555.

At operation 1540, the TR-STA 1510 can receive LL traffic from an upper layer. In an embodiment, the TR-STA 1510 can receive the LL traffic during transmission of the downlink data or PPDU (e.g., during the transmission of the first D-PPDU). In one embodiment, the TR-STA 1510 can receive the LL traffic at a buffer of a memory of the TR-STA 1510.

At operation 1545, the BSS-STA 1515 can receive LL traffic as well (e.g., receive second LL traffic from an upper layer). In an embodiment, the TR-STA 1510 and the BSS-STA 1515 can receive the LL traffic simultaneously. In other embodiments, the BSS-STA 1515 can receive the LL traffic during the transmission of the first PPDU, whether it is before or after the TR-STA 1510. In an embodiment, the BSS-STA 1515 can receive the second LL traffic at a buffer in a memory of the second STA.

At operation 1550, the TR-STA 1510 can begin counting SIFS. In an embodiment, the TR-STA 1510 initiates a count for the SIFS while receiving the PPDU based on the bit indication having the first value. In an embodiment, the TR-STA 1510 initiates the count at a start of a padding field or packet extension (PE) field of the PPDU. That is, the TR-STA 1510 begins counting the SIFS during the transmission of the first PPDU based on the first PPDU having the bit indication set to the first value. In an embodiment, the TR-STA 1510 begins counting the SIFS as part of a preemption operation ensuring that LL traffic can be sent to the AP 1505 efficiently.

At operation 1555, the BSS-STA 1515 can initiate a count for the predetermined interframe space (SIFS) after transmission of the PPDU. In an embodiment, the BSS-STA 1515 begins to count the SIFS after the transmission of the downlink data (e.g., PPDU) is completely finished. That is, because the BSS-STA 1515 does not receive the first D-PPDU, the BSS-STA 1515 does not begin count of the SIFS during the transmission. In other embodiments, if the TR-STA 1510 had received the bit indication having the second value, the TR-STA 1510 may also begin counting the SIFS after the transmission of the first D-PPDU.

At operation 1560, the TR-STA 1560 can transmit a preemption request (PR) frame to the AP 1505 after a predetermined interframe space (e.g., SIFS) has elapsed from the reference point in the downlink.

At operation 1565, the AP 1565 prepares for LL traffic. In an embodiment, the AP 1505 can refrain from transmitting a second D-PPDU. That is, the AP 1505 can pause transmission of the downlink data based on receiving the PR frame, so that the TR-STA 1510 is afforded an opportunity to transmit its LL traffic.

At operation 1570, the TR-STA 1510 performs channel contention in order to gain access to the medium.

At operation 1575, the BSS-STA 1515 determines a medium (e.g., the medium coupling the AP 1505, the TR-STA 1510, and the BSS-STA 1515) is busy based on initiating the count for the predetermined interframe space (SIFS) after transmission of the downlink frame (PPDU). That is, the BSS-STA 1515 refrains from transmitting a PR frame based on the medium being busy. In that, because the bit indication is set to the first value, the TR-STA 1510 is given priority to transmit its LL traffic first. Since the TR-STA 1510 begins counting its SIFS first, by the time the BSS-STA 1515 is done counting its SIFS, the TR-STA 1510 has already transmitted its PR frame and the medium is busy. Accordingly, the BSS-STA 1515 does not transmit its LL traffic at that time.

At operation 1580, the TR-STA 1510 transmits an uplink frame including its LL traffic received at operation 1540.

At operation 1585, the AP 1505 transmits an acknowledgment (e.g., a block acknowledgement (BA)) responsive to transmitting the uplink frame including the low latency traffic.

At operation 1585, the AP 1505 resumes PPDU transmission—e.g., the AP transmits another downlink frame after transmitting the acknowledgement. That is, the AP 1505 may process the LL traffic received from the TR-STA 1510 and then proceed to resume PPDU transmission by transmitting a second PPDU (e.g., a second PPDU). In one embodiment, the second PPDU includes a bit indicator having a second value indicating a second specific point at which to initiate the count for the SIFS for the preemption request, where the second specific point is after transmission of the second PPDU. That is, the TR-STA 1510 can receive the second PPDU including the bit indication having the second value. In an embodiment, the TR-STA 1510 can receive, while receiving the second PPDU, second LL traffic at the buffer of the memory. In an embodiment, the TR-STA 1510 can initiate a second count for a second SIFS after receiving the second PPDU based on the bit indicator having the second value. In this embodiment, the TR-STA 1510 would transmit a second PR request after the elapse of the second count. In such embodiments, the second PR request frame is transmitted at a second time after transmission of a PPDU that is greater than a first time the first PR request frame is transmitted after transmission of the PPDU.

By utilizing the prioritization preemption procedure 1500, the STA that is already in communication with the AP 1505 (e.g., the TR-STA 1510) is given priority over other STAs in the same BSS that are not TXOP responders. Accordingly, the efficiency of medium utilization can increase, and the overall latency of the system can be reduced.

The various illustrative blocks, units, modules, components, methods, operations, instructions, items, and algorithms may be implemented or performed with a processing circuitry (e.g., the blocks, units, modules, and components herein may also refer to circuits or circuitry performing the methods, operations, instructions, items, and algorithms described herein.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
receiving, from an access point (AP), a downlink frame including information indicating a reference point in the downlink frame;
transmitting a preemption request frame after a predetermined interframe space has elapsed from the reference point in the downlink frame when the STA has low latency traffic to transmit; and
transmitting an uplink frame including the low latency traffic after transmitting the preemption request frame.

2. The STA of claim 1, wherein the reference point is at a start of a padding field of the downlink frame.

3. The STA of claim 1, wherein the information is located in a medium access control (MAC) header or in a signal field of the downlink frame.

4. The STA of claim 1, wherein the processor is further configured to cause:
receiving, from the AP, an acknowledgement responsive to transmitting the uplink frame including the low latency traffic; and
receiving, from the AP, another downlink frame after receiving the acknowledgement.

5. The STA of claim 1, wherein the reference point is before an end of the downlink frame.

6. The STA of claim 1, wherein the reference point is at an end of the downlink frame.

7. The STA of claim 1, wherein the reference point indicates a specific point in the downlink frame at which to initiate a count for the predetermined interframe space.

8. An access point (AP) in a wireless network, comprising:
a memory; and
a processor coupled to the memory, the processor configured to cause:
obtaining a transmit opportunity to transmit downlink data;
transmitting, to a station (STA), a downlink frame including information indicating a reference point in the downlink frame;
receiving a preemption request frame after a predetermined interframe space has elapsed from the reference point in the downlink frame indicating the STA has low latency traffic to transmit; and
receiving an uplink frame including the low latency traffic after receiving the preemption request frame.

9. The AP of claim 8, wherein the processor is further configured to cause:
pausing transmission of the downlink data based at least in part on receiving the preemption request; and
transmitting a second downlink frame and resume transmission of the downlink data after receiving the LL traffic.

10. The AP of claim 8, wherein the reference point is at a start of a padding field of the downlink frame.

11. The AP of claim 8, wherein the AP is in a basic service set (BSS) including the STA that is a transmit opportunity responder and a second STA that is not a transmit opportunity responder, wherein the second STA is configured to cause:
receiving second low latency traffic at a buffer in a memory of the second STA;
initiating a count for the predetermined interframe space after the transmission of the downlink frame; and
determining a medium coupled to the AP, the STA, and the second STA is busy based on initiating the count for the predetermined interframe space after transmission of the downlink frame.

12. The AP of claim 8, wherein the reference point is before an end of the downlink frame.

13. The AP of claim 8, wherein the reference point is at an end of the downlink frame.

14. A method performed by a station (STA) in a wireless network, comprising:
receiving, from an access point (AP), a downlink frame including information indicating a reference point in the downlink frame;
transmitting a preemption request frame after a predetermined interframe space has elapsed from the reference point in the downlink frame when the STA has low latency traffic to transmit; and
transmitting an uplink frame including the low latency traffic after transmitting the preemption frame request.

15. The method of claim 14, wherein the reference point is at a start of a padding field of the downlink frame.

16. The method of claim 14, wherein the information is located in a medium access control (MAC) header or in a signal field of the downlink frame.

17. The method of claim 14, further comprising:
receiving, from the AP, an acknowledgment responsive to transmitting the uplink frame including the low latency traffic; and
receiving, from the AP, another downlink frame after receiving the acknowledgement.

18. The method of claim 14, wherein the reference point is before an end of the downlink frame.

19. A method of claim 14, wherein the reference point is at an end of the downlink frame.

20. The method of claim 14, wherein the reference point indicates a specific point in the downlink frame at which to initiate a count for the predetermined interframe space.
